(19) United States
(12) Patent Application Publication
(10) Pub. No.: US 2024/0171724 A1
(43) Pub. Date: May 23, 2024

(54) NEO 360: NEURAL FIELDS FOR SPARSE VIEW SYNTHESIS OF OUTDOOR SCENES

(71) Applicant: TOYOTA RESEARCH INSTITUTE, INC., LOS ALTOS, CA (US)

(72) Inventors: MUHAMMAD ZUBAIR IRSHAD, San Jose, CA (US); SERGEY ZAKHAROV, San Francisco, CA (US); KATHERINE Y. LIU, Mountain View, CA (US); VITOR GUIZILINI, Santa Clara, CA (US); THOMAS KOLLAR, Los Altos, CA (US); ADRIEN D. GAIDON, San Jose, CA (US); RARES A. AMBRUS, San Francisco, CA (US)

(73) Assignees: TOYOTA RESEARCH INSTITUTE, INC., LOS ALTOS, CA (US); TOYOTA JIDOSHA KABUSHIKI KAISHA, TOYOTA-SHI (JP)

(21) Appl. No.: 18/487,956

(22) Filed: Oct. 16, 2023

Related U.S. Application Data
(60) Provisional application No. 63/488,880, filed on Mar. 7, 2023.
(60) Provisional application No. 63/424,742, filed on Nov. 11, 2022.

(51) Int. Cl. H04N 13/275; G06T 7/90; G06T 9/00; G06V 10/42; G06V 10/44; G06V 10/771

(52) U.S. Cl. CPC H04N 13/275; G06T 7/90; G06T 9/00; G06V 10/42; G06V 10/44; G06V 10/771; G06T 2207/10024

(57) ABSTRACT

The present disclosure provides neural fields for sparse novel view synthesis of outdoor scenes. Given just a single or a few input images from a novel scene, the disclosed technology can render new 360° views of complex unbounded outdoor scenes. This can be achieved by constructing an image-conditional triplanar representation to model the 3D surrounding from various perspectives. The disclosed technology can generalize across novel scenes and viewpoints for complex 360° outdoor scenes.

### CROSS-REFERENCE TO RELATED APPLICATIONS

This application claims the benefit of U.S. Provisional Patent Application No. 63/488,880 filed on Mar. 7, 2023 and U.S. Provisional Patent Application No. 63/424,742 filed on Nov. 11, 2022, each of which is incorporated by reference herein in its entirety.

### TECHNICAL FIELD

The present disclosure relates generally to neural fields for sparse view synthesis of outdoor scenes. More particularly, examples of the present disclosure relate to novel view synthesis and rendering new 360° views of complex unbounded outdoor scenes, given just a single or a few input images from a novel scene.

### DESCRIPTION OF RELATED ART

Advances in learning-based implicit neural representations have demonstrated promising results for high-fidelity novel-view synthesis, doing so from multi-view images. The capability to infer accurate 3D scene representations has benefits in autonomous driving and robotics, among other fields.

Despite great progress made in neural fields for indoor novel view synthesis, however, these techniques are limited in their ability to represent complex urban scenes as well as decomposing scenes for reconstruction and editing. Specifically, previous formulations have focused on per-scene optimization from a large number of views, which increases their computational complexity. This also limits their application to complex scenarios such as data captured by a moving vehicle where the geometry of interest is observed in just a few views.

Another line of work focuses on object reconstructions from single-view red green blue (RGB) inputs. However, these approaches require accurate panoptic segmentation and 3D bounding boxes as their inputs, which are implemented by multi-stage pipelines that can lead to error-compounding.

### BRIEF SUMMARY OF THE DISCLOSURE

Example embodiments of the disclosed technology provide neural fields for sparse view synthesis of outdoor scenes. Examples of the present disclosure relate to few-view novel-view synthesis and rendering new 360° views of complex unbounded outdoor scenes, given just a single or a few input images from a novel scene. In examples of the present disclosure, such few-shot novel view synthesis and rendering can be achieved by constructing an image-conditional triplanar representation to model the 3D surroundings from various perspectives. The disclosed technology can generalize across novel scenes and viewpoints for complex 360° outdoor scenes.

As noted above, recent implicit neural representations have shown great results for novel-view synthesis. However, existing methods require expensive per-scene optimization from many views, thereby limiting their application to real-world unbounded urban settings where the objects of interest or backgrounds are observed from very few views.

To address this challenge, the present disclosure introduces a new approach referred to herein as NeO 360: Neural Fields for Sparse View Synthesis of Outdoor Scenes. NeO 360 is a generalizable system/method which can perform 360° novel view synthesis of new scenes from a single or a few posed red green blue (RGB) images. Among the notable features of this approach are capturing the distribution of complex real-world outdoor 3D scenes and using a hybrid image-conditional triplanar representation which can be queried from any world point.

In some example implementations of the present disclosure the NeO 360 system/method enables learning from a large collection of unbounded 3D scenes while offering generalizability to new views and novel scenes from as few as a single image during inference. The approach of the present disclosure has been demonstrated on a proposed challenging 360° unbounded dataset, referred to herein as “NeRDS360”: “NeRF for Reconstruction, Decomposition and Scene Synthesis of 360° outoor scenes” and further described below. The NeO 360 system/method in examples of the present disclosure can outperform conventional generalizable methods for novel-view synthesis while also offering editing and composition capabilities.

Examples of the present disclosure use an image-conditional triplanar representation to condition neural fields, which the present disclosure shows to be quite effective at learning unbounded scene priors while offering generalizability from one or a few views.

Existing datasets mostly evaluate on indoor scenes and provide little or no compositionality (i.e., multi-objects, 3D bounding boxes) for training or evaluating. While some existing datasets provide 360° coverage, the number of scenes in these datasets are small, and therefore it can be difficult to evaluate the performance of these methods at scale.

Due to such challenges, examples of the disclosed technology collect a large scale outdoor dataset in simulation offering similar camera distributions as Neural Radiance Fields (NeRFs) for 360° outdoor scenes. An example dataset of the present disclosure, described in detail below, can offer dense viewpoint annotations for outdoor scenes and is significantly larger than existing outdoor datasets. This can allow for building effective priors for large scale scenes which can lead to improved generalizable performance on new scenes with very limited views.

The present disclosure in one example embodiment provides a computer-implemented method for few-shot novel view synthesis of a novel scene. The method includes inputting at least one posed RGB image of the novel scene into an encoder; encoding with the encoder the at least one inputted posed RGB image and inputting the at least one encoded RGB image into a far multi-layer perceptron (MLP) for representing background and a near multi-layer perceptron (MLP) for representing foreground; outputting the background images from the far MLP as depth-encoded features, and outputting the foreground images from the near MLP. The method also includes aggregating the outputted depth-encoded images and the foreground images; creating a convolutional two-dimensional (2D) feature map from the aggregated depth-encoded features and the foreground images; and producing a triplanar representation from the 2D feature map. The method further includes transforming the triplanar representation into a global features representation to model 3D surroundings of the novel scene; extracting local and global features from the global features representation at projected pixel locations; and inputting the extracted local and global features into a decoder to render local and global feature representations of the novel scene from the modeled 3D surroundings. A system and a non-transitory computer-readable medium are also provided.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example of an all-wheel drive hybrid vehicle with which embodiments of the systems and methods disclosed herein may be implemented.

FIG. 2 illustrates an example architecture for few-view novel view synthesis of outdoor scenes using neural fields, in accordance with one embodiment of the systems and methods described herein.

FIG. 3 shows an overview of a generalizable approach few-view novel view synthesis of outdoor scenes according to an example embodiment of the present disclosure.

FIG. 4 shows a system for few-view novel view synthesis of outdoor scenes, according to an example embodiment of the present disclosure.

FIG. 5 shows an architectural design or system according to another example embodiment of the present disclosure.

FIG. 6 shows a method for few-view novel view synthesis of outdoor scenes using neural fields according to an example embodiment.

FIG. 7 shows an example of samples from the NeRDS360 dataset comprising unbounded scenes with full multi-view annotations and diverse scenes.

FIG. 8 shows an example camera distribution for 1, 3, and 5 source views according to an example implementation of the present disclosure.

FIG. 9 illustrates a proposed multi-view dataset for 360 neural scene reconstructions for outdoor scenes according to an example implementation of the present disclosure.

FIG. 10 shows qualitative results according to one example, specifically, scene decomposition quality results showing a 3-view scene decomposed into individual objects along with novel views on the NeRDS360 dataset, according to an example implementation of the present disclosure.

FIG. 11 is an example computing component that may be used to implement various features of embodiments described in the present disclosure.

The figures are not exhaustive and do not limit the present disclosure to the precise form disclosed.

### DETAILED DESCRIPTION

Examples of the present disclosure provide neural fields for few-view novel view synthesis of outdoor scenes. Given just a single or a few input images from a novel scene, the disclosed technology can perform novel view synthesis and render new 360° views of complex unbounded outdoor scenes. This can be achieved by constructing an image-conditional triplanar representation to model the 3D surroundings from various perspectives. The disclosed technology can generalize across novel scenes and viewpoints for complex 360° outdoor scenes.

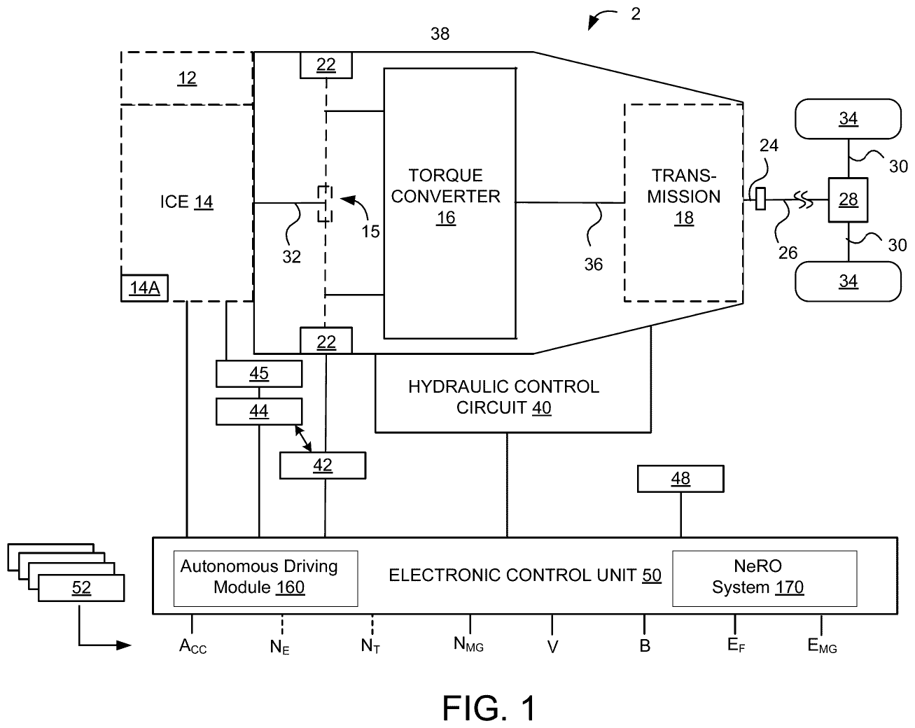

As noted above, this approach is referred to as Neural Fields for Sparse View Synthesis of Outdoor Scenes. The NeO 360 system 170 of FIG. 1, discussed in detail below, provides an example embodiment. The NeO 360 system 170 utilizes neural fields for sparse view synthesis of outdoor scenes.

Examples of the disclosed technology infer the representation of 360° unbounded scenes from just a single or a few posed RGB images of a novel outdoor environment. This can avoid the challenge of needing to acquire denser input views of a novel scene in order to obtain an accurate 3D representation, as well as the computational expense of per-scene optimization from many views.

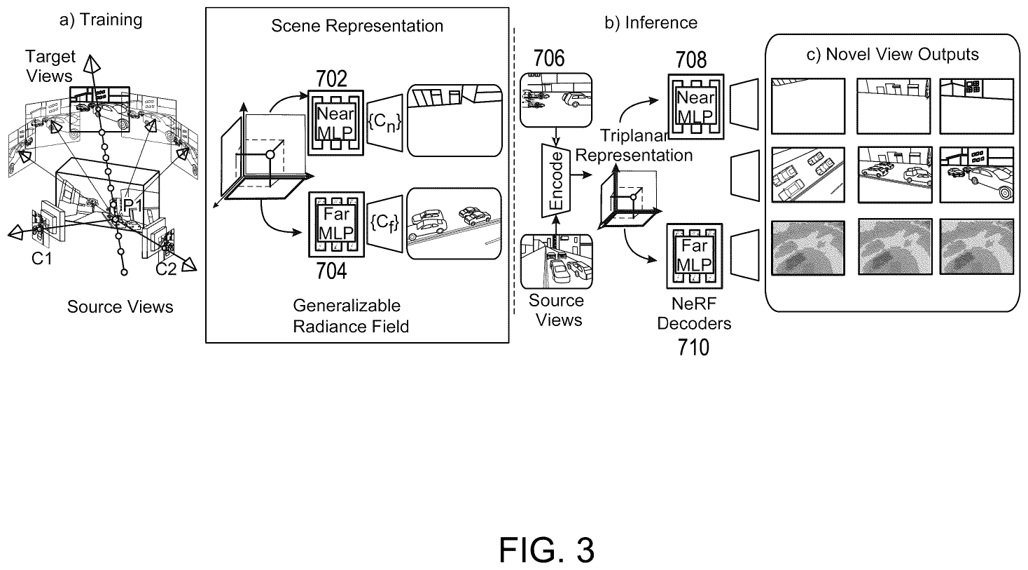

Given RGB images from a single or a few views of a novel scene, the NeO 360 system 170 infers a 3D scene representation capable of performing novel view synthesis and rendering of 360° scenes. To achieve this, the NeO 360 system 170 employs a hybrid local and global features representation comprised of a triplanar representation that can be queried for any world point. FIG. 3 shows an overview of a generalizable approach for sparse novel view synthesis of outdoor scenes according to an example of the present disclosure. FIG. 3 is an overall conceptual diagram; the specifics will be explained in more detail below.

FIG. 3 shows stages of a) training and scene representation, b) inference, and c) novel view outputs based on the inference. In training stage a), the model learns from a large collection of 3D scenes. An example training set is described below. In an example embodiment, the disclosed technology trains/optimizes a single model for all observed scenes. The model samples one or more images (e.g., 3 images) from the Source Views. More specifically, one or a few input images I=[I₁ . . . Iₙ] of a complex scene are input into the Training Stage, where n=1 to 5. (Of course, this is merely an example range for n, and other ranges could be used.) Their corresponding camera poses γ=[γ₁ . . . γₙ] are also input into the Training Stage, where γ=[R|T]. In the Training Stage the source views I are encoded to target views.

Then, operating in a generalizable radiance field and using near and far multi-layer perceptrons (MLPs) 702, 704, the model performs scene representation. In the Scene Representation Stage of FIG. 3, the encoded images I are input to the near and far MLPs 702, 704 where density and radiance fields are inferred for near and far backgrounds using hybrid local and global features for conditioning the density and radiance field decoders (MLPs 708, 710) instead of just positions and viewing directions as employed in the conventional NeRF formulation.

In the Inference Stage b), an encoder 706 encodes source views and then, notably, global features are represented in the form of triplanes. This triplanar representation is constructed as three perpendicular cross-planes, where each plane models the 3D surroundings from one perspective, and by merging the planes a thorough description of the 3D scene can be achieved. This image-conditional triplanar representation of the disclosed technology can efficiently encode information from image-level features while offering a compact query-able representation for any world point. Examples of the disclosed technology use these features combined with the residual local image-level features to optimize multiple unbounded 3D scenes from a large collection of images from various scenes. The 3D scene representation can build a strong prior for complete 3D scenes, which can enable efficient novel view synthesis for outdoor scenes from just a few posed RGB images. In the Novel View Outputs Stage c), following the encoding and triplanar representations, the NeRF decoders 708, 710 produce novel view outputs.

The systems and methods disclosed herein may be implemented in any of a number of robotics applications, including grasping, manipulation, and others. The systems and methods disclosed herein may also be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for providing neural fields for sparse novel view synthesis of outdoor scenes can be implemented in other types of vehicles including gasoline or diesel powered vehicles, fuel-cell vehicles, electric vehicles, or other vehicles.

FIG. 1 illustrates a drive system of a vehicle 2 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump, and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 2 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50 execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In example embodiments the vehicle 2 is configured to switch selectively between an autonomous mode, one or more semi-autonomous operational modes, and/or a manual mode. In example embodiments the vehicle 2 is an autonomous vehicle that operates in an autonomous mode which refers to navigating and/or maneuvering the vehicle 2 along a travel route using one or more computing systems to control the vehicle 2 with minimal or no input from a human driver. Accordingly the electronic control unit 50 of the vehicle 2 for example can include one or more autonomous driving module(s) 160. The autonomous driving module(s) 160 can be configured to receive data from the sensor system 52 and/or any other type of system capable of capturing information relating to the vehicle 2 and/or the external environment of the vehicle 2.

In example embodiments the one or more memory storage units in the ECU 50 can store map data. The map data can include maps or terrain maps of one or more geographic areas, or information or data on roads, traffic control devices, road markings, structures, features, and/or landmarks in the one or more geographic areas. The map data can be in any suitable form including aerial views of an area, ground views of an area, measurements, dimensions, distances, elevational data, and/or information for one or more items included in the map data and/or relative to other items included in the map data. The map data can include a digital map with information about road geometry.

In the example illustrated in FIG. 1, electronic control unit 50 receives information from a plurality of sensors 52 included in vehicle 2. For example, electronic control unit 50 may receive signals that indicate vehicle operating conditions or characteristics, or signals that can be used to derive vehicle operating conditions or characteristics. These may include, but are not limited to accelerator operation amount, Acc, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, and battery SOC (i.e., the charged amount for battery 44 detected by an SOC sensor). Accordingly, vehicle 2 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In example embodiments the vehicle sensor(s) 52 can detect, determine, and/or sense information about the vehicle 2 itself, or can be configured to detect, and/or sense position and orientation changes of the vehicle 2, such as, for example, based on inertial acceleration. In example embodiments the vehicle sensor(s) 52 can include one or more accelerometers, one or more gyroscopes, an inertial measurement unit (IMU), a dead-reckoning system, a global navigation satellite system (GNSS), a global positioning system (GPS), a navigation system, and/or other suitable sensors including a speedometer to determine a current speed of the vehicle 2.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The NeO 360 system 170 can be controlled by the ECU 50. The NeO 360 system 170 can receive sensor data 250 from one or more sensors 52 and provide neural fields for sparse novel view synthesis of outdoor scenes as discussed in detail below.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

Moreover, while arrangements will be described herein with respect to vehicles, it will be understood that embodiments are not limited to vehicles or to autonomous navigation of vehicles but may include for example robotics manipulation, augmented reality, and scene understanding, among others. In some implementations, the vehicle 2 may be any robotic device or form of motorized transport that, for example, includes sensors to perceive aspects of the surrounding environment, and thus benefits from the functionality discussed herein associated with providing neural fields for sparse novel view synthesis of outdoor scenes. Furthermore, while the various elements are shown as being located within the vehicle 2 in FIG. 1, it will be understood that one or more of these elements can be located external to the vehicle 2. Further, the elements shown may be physically separated by large distances. For example, as discussed, one or more components of the disclosed system can be implemented within the vehicle 2 while further components of the system are implemented within a cloud-computing environment or other system that is remote from the vehicle 2.

To enable building a strong prior representation of outdoor unbounded scenes and given the scarcity of available multi-view data to train methods like NeRF, the present disclosure in one example utilizes a new large scale 360° unbounded dataset comprising more than 70 scenes across 3 different maps. This dataset is described in further detail below. Of course, this dataset is only an example and the disclosed technology can be used with other datasets as well. In any event the effectiveness of the approach has been demonstrated on such multi-view unbounded dataset in both a few-shot novel-view synthesis and a prior-based sampling task. In addition to learning a strong 3D representation for complete scenes, the disclosed technology also allows for inference-time pruning of rays using 3D ground truth bounding boxes, thus enabling compositional scene synthesis from a few input views.

In summary, examples of the present disclosure provide, inter alia, a generalizable NeRF architecture for outdoor scenes based on a triplanar representation to extend the NeRF formulation for effective few-shot novel view synthesis for 360° unbounded environments. Examples of the present disclosure can also work with a large scale synthetic 360° dataset, referred to herein as “NeRDS360”: “NeRF for Reconstruction, Decomposition and Scene Synthesis of 360° outoor scenes”, and further described below, for 3D urban scene understanding comprising multiple objects, capturing high-fidelity outdoor scenes with dense camera viewpoints. The approach of the present disclosure can significantly outperforms all baselines for few-shot novel view synthesis on the NeRDS360 dataset.

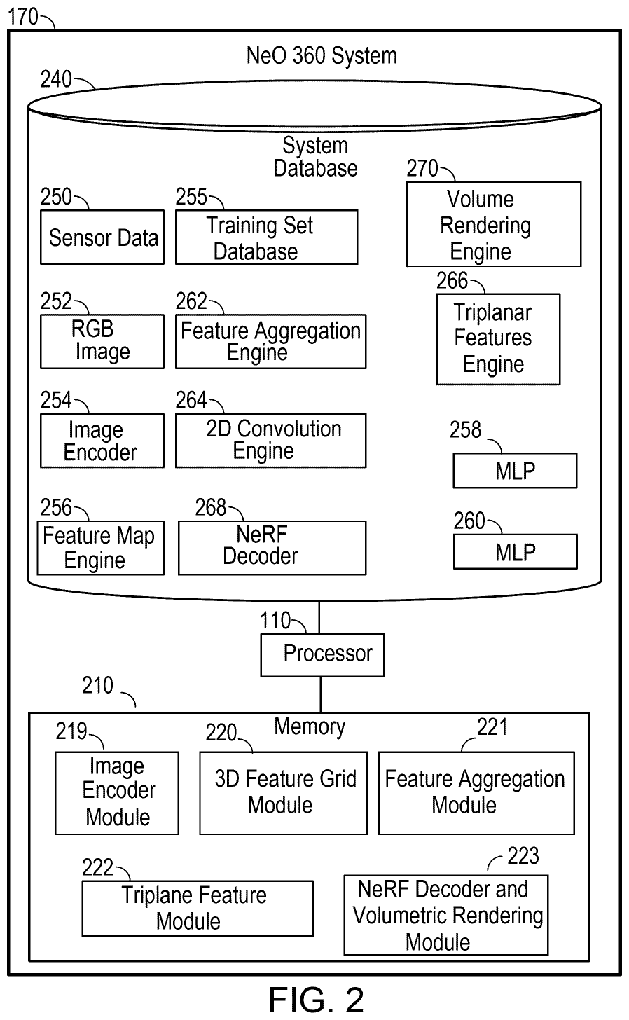

FIG. 2 illustrates an example architecture for sparse novel view synthesis of outdoor scenes using neural fields, in accordance with one embodiment of the systems and methods described herein. Referring now to FIG. 2, in this example, NeO 360 system 170 includes an image encoder module 219, a 3D feature grid module 220, a feature aggregation module 221, a triplane feature module 222, and a NeRF decoder and volumetric rendering module 223. The NeO 360 system 170 can receive sensor data 250 from one or more sensors 52. The NeO 360 system 170 can be implemented as an ECU or as part of an ECU such as, for example electronic control unit 50 as shown in FIG. 1. In other embodiments, the NeO 360 system 170 can be implemented independently of the electronic control unit 50.

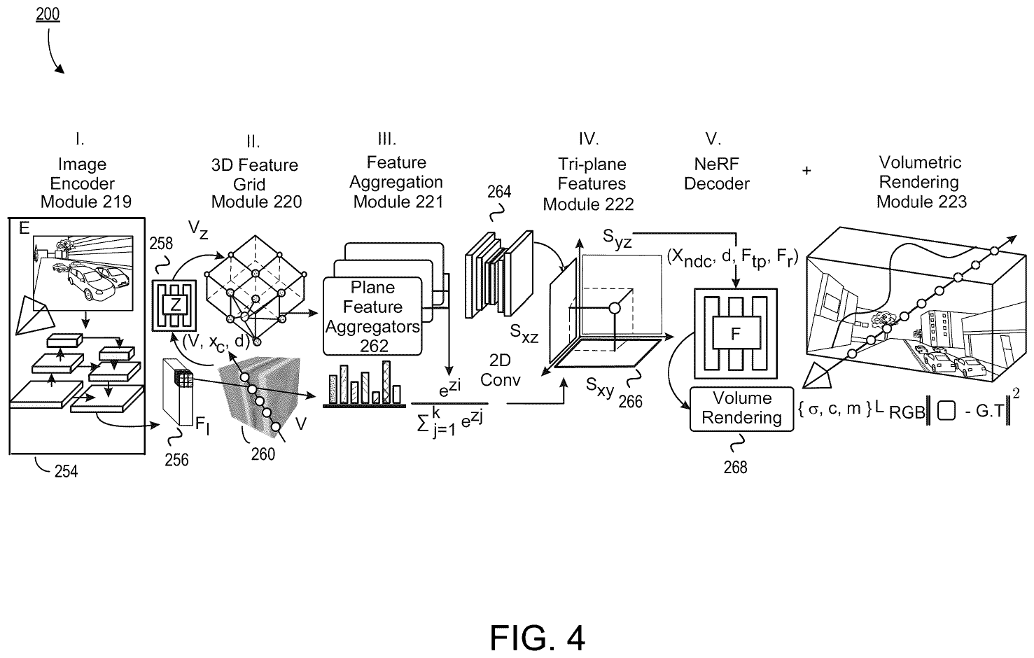

The NeO 360 system 170 of FIG. 2 comprises system database 240 that includes the following components which are described in more detail in connection with FIG. 4. Specifically, the system database 240 includes the sensor data unit 250 discussed above as well as red green blue (RGB) image unit 252, image encoder 254, feature map engine 256, MLPs 258, 260, feature aggregation engine 262, 2D convolution engine 264, triplanar features engine 266, NeRF decoder 268, and volume rendering engine 270.

The NeO 360 system 170, in various embodiments, can be implemented partially within a vehicle such as the vehicle 2 of FIG. 1 or within a robotics device having sensors for perceiving various conditions, or as a cloud-based service. For example, in one approach, functionality associated with at least one module of the NeO 360 system 170 is implemented within the vehicle 2 while further functionality is implemented within a cloud-based computing system.

With reference initially to FIGS. 2 and 4, examples of the NeO 360 system 170 of FIG. 1 are further illustrated. The NeO 360 system 170 is shown as including a processor 110 which may be a processor located in electronic control unit 50 from the vehicle 2 of FIG. 1, or in a robotics device having sensors for perceiving various conditions, or in other suitable environments. Accordingly, the processor 110 may be a part of the NeO 360 system 170, the NeO 360 system 170 may include a separate processor from the processor 110 of the vehicle 2, or the NeO 360 system 170 may access the processor 110 through a data bus or another communication path.

In one example embodiment, the NeO 360 system 170 includes a memory 210 (which may be a memory located in the electronic control unit 50 of FIG. 1) that stores image encoder module 219, 3D feature grid module 220, feature aggregation module 221, triplane feature module 222, and NeRF decoder and volumetric rendering module 223. The memory 210 may be a random-access memory (RAM), read-only memory (ROM), a hard-disk drive, a flash memory, or other suitable memory for storing the modules 219-223. The modules 219-223 may be, for example, computer-readable instructions that when executed by one or more processors such as the processor 110 cause the processor 110 to perform the various functions disclosed herein.

Processor 110 can include one or more GPUs, CPUs, microprocessors, or any other suitable processing system. Processor 110 may include a single core or multicore processors. The memory 210 may include one or more various forms of memory or data storage (e.g., flash, RAM, etc.) that may be used to store the calibration parameters, images (analysis or historic), point parameters, instructions and variables for processor 110 as well as any other suitable information. Memory 210, can be made up of one or more modules of one or more different types of memory, and may be configured to store data and other information as well as operational instructions that may be used by the processor 110 to modules 219-223.

With reference to FIG. 2, the modules 219-223 generally include instructions that function to control the processor 110 to receive data inputs. The data inputs may be from one or more sensors (e.g., sensors 52 of the vehicle 2). The inputs are, in one embodiment, observations of one or more objects in an environment proximate to the vehicle 2 and/or other aspects about the surroundings. As provided for herein, the image encoder module 219 acquires sensor data 250 that includes RGB images.

In addition to locations of surrounding vehicles, the sensor data 250 may also include, for example, information about lane markings and so on. Moreover, the image encoder module 219, in one embodiment, controls the sensors 52 to acquire the sensor data 250 about an area that encompasses 360° about the vehicle 2 in order to provide a comprehensive assessment of the surrounding environment. Of course, in alternative embodiments, the image encoder module 219 may acquire the sensor data 250 about a forward direction alone when, for example, the vehicle 2 is not equipped with further sensors to include additional regions about the vehicle and/or the additional regions are not scanned due to other reasons (e.g., unnecessary due to known current conditions).

As noted above the NeO 360 system 170 carries out processes including providing neural fields for sparse novel view synthesis of outdoor scenes, in accordance with example embodiments of the application. In the example embodiment shown in FIG. 4 there are five main stages of this process, referred to herein as Stages I through V. The five stages will be summarized and then described in detail below.

FIG. 4 shows a system 200 for sparse novel view synthesis of outdoor scenes, according to an example embodiment of the present disclosure. More specifically, FIG. 4 shows Stages I through V of the system 200. Stage I is directed to image encoding and in one example is performed by image encoder module 219 of FIG. 2. Stage II is directed to a 3D feature grid and in one example is performed by 3D feature grid module 220 of FIG. 2. Stage III is directed to feature aggregation and in one example is performed by feature aggregation module 221 of FIG. 2. Stage IV is a triplanar features stage comprising image-conditional triplanar representation and in one example is performed by triplanar features module 222 of FIG. 2. Here, image-conditional refers to generating 3D scenes from posed images. Stage V is a decoding and rendering stage and in one example is performed by NeRF decoder and volumetric rendering module 223 of FIG. 2. Each of these Stages I through V are now described in more detail as follows in connection with the example embodiment of FIG. 4.

### Stage I—Image Encoding

In Stage I, one or a few input images I=[I₁ . . . Iₙ] of a complex scene are input into image encoder 254. In this example n=1 to 5 but the present disclosure is not limited to this example and other values for n could be used. Their corresponding camera poses γ=[γ₁ . . . γₙ] are also input into the image encoder 254, where γ=[R|T]. The image encoder 254 uses training data from, e.g., training dataset database 255. Database 255 holds training dataset data such as the example training set data described below to encode source views and decode from target views. Target views can comprise any views other than source views in training. They can include all evaluation views which are not source views, i.e. other surrounding views we render the scene from. Stage I may be performed for example by the image encoder module 219 of FIG. 2.

### Stage II—3D Feature Grid and Scene Representation

In Stage II, the positions, viewing directions and local and global features from encoded images I are input into multi-layer perceptrons (MLPs) 258, 260. MLP 258 is a neural net used as a “far” MLP for representing background images. MLP 260 is a neural net used as a “near” MLP for representing foreground images. Accordingly, Stage II is a scene representation stage in which the positions, viewing directions and local and global features from encoded images I are input to far and near MLPs 258, 260.

As all features along a camera ray are identical in the feature grid, the disclosed technology learns the depth of individual features by MLP 258, V_{Z}=Z(V_{F}, x_{c}, d), which takes as its input concatenated features in the grid (feature volume V_{F}), positions of the grid in the camera frame (x_{c}), and directions (d) from the positions of the grid in the world frame x_{w} to the camera frame. MLP 258 outputs depth-encoded features V_{Z}. MLP 258 is an additional MLP.

Accordingly, in Stage II, with an eye towards constructing feature triplanes from an input image, low resolution spatial feature representations are first extracted, for example by using an ImageNet pretrained ConvNet backbone E which transforms input image I∈R^{Hi×Wi×3} to a 2D feature map Fₗ∈R^{Hi/2×Wi/2×C}. The obtained local features are projected backwards along every ray to the 3D feature volume (V_{F}) using camera pose γᵢ and intrinsic Kᵢ. Stage II may be performed for example by the 3D feature grid module 220 of FIG. 2. K represents the intrinsic matrix of the camera. R denotes the input or feature space, i.e. the dimensions.

### Stage III—Feature Aggregation

The feature aggregation module 221 uses feature aggregation engine 262 to produce, from plane feature aggregations, 2D convolutions for use in the triplane features of Stage IV. Stage III may be performed for example by the feature aggregation module 221 of FIG. 2. Feature aggregation is illustrated by the equations below in stage IV.

### Stage IV—Image-Conditional Triplanar Representation

Next, in Stage IV, triplane features are obtained. Although producing high-fidelity scene synthesis, NeRF is limited in its ability to generalize to novel scenes. Accordingly, in order to effectively use scene-priors and learn from a large collection of unbounded 360° scenes, the present disclosure provides an image-conditional triplanar representation. This triplanar representation can model 3D scenes with full expressivity at scale without omitting any of its dimensions (as in 2D or BEV-based representations) while avoiding cubic complexity (as in voxel-based representations). The triplanar representation of examples of the present disclosure comprises three axis-aligned orthogonal planes S=[S_{xy}, S_{xz}, S_{yz}],∈R^{3×C×D×D} where D×D is the spatial resolution of each plane with feature C. More specifically, the triplane features are obtained using learnt weights (wᵢ) over individual volumetric feature dimensions as follows:

S_{xY}=Σᵢ [symbol] _{xY}_{ᵢ} V_{Z}_{ᵢ}, [symbol] _{xY}=A_{xy}(V_{Z}_{ᵢ}, x [symbol] _{_{z}}) (Equation 1)

S_{xZ}=Σᵢ [symbol] _{xZ}_{ᵢ} V_{Z}_{ᵢ}, [symbol] _{xz}=A_{xZ} (V_{Z}_{ⱼ}, x [symbol] _{_{y}}) (Equation 2)

S_{YZ}=Σᵢ [symbol] _{YZ}_{ᵢ} V_{Z}_{ᵢ}, [symbol] _{YZ}=A_{YZ} (V_{Z}_{ⱼ}, x [symbol] _{ₓ}) (Equation 3)

In the above equations, A_{xy}, A_{xz} and A_{yz} denote feature aggregation MLPs and w_{xy}, w_{xz} and w_{yz} are softmax scores obtained after summing over the z, y, and x dimensions, respectively. One motivation to project features into respective planes is to avoid the computationally cubic complexity of 3D convolutional neural networks (CNNs) and at the same time be more expressive than BEV or 2D feature representations which are computationally more efficient than voxel-based representations but their expressiveness can suffer by omitting the z-axis.

The present disclosure instead relies on 2D convolutions from the feature aggregation stage (Stage III) to transform the built image-conditional triplanes into a new G-channel output, where G=C/4, while up-sampling the spatial dimension of planes from D×D to image feature space (i.e., H/2×W/2). The learnt convolutions act as inpainting networks to fill in missing features. As shown in FIG. 4, the triplanar representation of the present disclosure acts as a global feature representation, in that intuitively a complex scene can be better represented when examined from various perspectives. This is because each may offer complementary information that can help understand the scene more effectively.

### Stage V—NeRF Decoding and Volumetric Rendering

With regard to deep residual local features, for the radiance field decoding stage, examples of the disclosed technology use the features fᵣ as a residual connection into the rendering MLP (NeRF decoder 268). The disclosed technology obtains fᵣ from FI by projecting the world point x into its source view using its camera parameters γᵢ, Kᵢ and extracting features at the projected pixel locations through bilinear interpolation. It is noted that both local and global feature extraction pathways share the same weights θ_{E} and encoder E (image encoder 254). The inventors of the present disclosure have found that for complex urban unbounded scenes, using just local features similar to existing techniques typically leads to ineffective performance for occlusions and far away 360° views, as shown herein. Using only global features, on the other hand, typically leads to what are referred to as “hallucinations.” The disclosed technology can combine both local and global feature representations effectively, which can result in accurate 360° few-view novel-view synthesis from as minimal as a single view of an unbounded scene.

The radiance field decoder D, also referred to herein as NeRF decoder 268, is tasked with predicting a color c and density a for any arbitrary 3D location x and viewing direction d from triplanes S and residual features fᵣ. Examples of the present disclosure use a modular implementation of rendering MLPs, one or more rendering MLPs being represented by NeRF decoder 268, with a notable difference from existing methods of using local and global features of the present disclosure for conditioning instead of just using positions and viewing directions as an input to the MLPs. A rendering MLP of NeRF decoder 268 is denoted as:

σ, c=D(x, d, fₜₚ, fᵣ) (Equation 4)

In the above equation, fₜₚ is obtained by orthogonally projecting point x into each plane in S and performing bilinear sampling. The three bilinearly sampled vectors are concatenated into fₜₚ=[S_{xy}(i,j), S_{xz}(j,k), S_{yz}(i,k)]. It is noted that this coordinate system is established using the view space of the input image, and then the positions and camera rays within this particular coordinate system are indicated. X refers to the 3D position, d refers to the viewing direction, fₜₚ refers to the triplane features, and f r refers to residual local features.

By utilizing the view space, the disclosed technology can successfully standardize the scales of scenes from various data sources, thereby enhancing its ability to generalize well. Although the disclosed technology gives reasonable results from a single-view observation, the NeO 360 system 170 can seamlessly integrate multi-view observations by pooling along the view dimension in the rendering MLPs 268.

As described herein, the NeRF decoder 268 renders an implicit 3D scene representation by learning a neural network f(x, θ)→(c, σ). This end-to-end differentiable function f outputs color cᵢ and density σᵢ for every query 3D position xᵢ and the viewing direction θᵢ as inputs. For each point evaluation, a four channel (c, σ) value is output, which is then alpha-composited (Equation 5) to render an image using volume rendering.

c=Σᵢwᵢcᵢ acc=Σᵢwᵢ (Equation 5)

wᵢ=αᵢΠ_{j<i}(1−αⱼ), αᵢ=1−exp (−σᵢ∥Xᵢ−Xᵢ+1∥) (Equation 6)

With regard to near and far decoding MLPs, an example of the present disclosure defines two rendering MLPs provided by NeRF decoder 268 for decoding color and density information as follows:

$$D ( . ) = \{ \begin{matrix}{D}_{fg} ( . ) if {\sum }_{i = 1}^{n} ( {x}_{i}^{2} + {𝓎}_{i}^{2} + {𝓏}_{i}^{2} ) < 1 \\ {D}_{bg} ( . ) if {\sum }_{i = 1}^{n} ( {x}_{i}^{2} + {𝓎}_{i}^{2} + {𝓏}_{i}^{2} ) > 1\end{matrix} \qquad ( Equation 7 )$$

In the above, coordinate remapping function (M) is defined similar to the original NeRF++ formulation to contract the 3D points that lie outside the unit sphere, where M maps points (x, y, z) outside the unit sphere to the new 4D coordinates (x′, y′, z′, 1/r), where (x′, y′, z′) represents the unit vector in the direction of (x, y, z) and r denotes the inverse radius along this dimension. This formulation can help further objects get less resolution in the rendering MLPs. For querying the triplanar representation, the disclosed technology uses uncontracted coordinates (x, y, z) in the actual world coordinates since the representation of the disclosed technology are planes instead of spheres. For rendering, the disclosed technology uses the respective contracted coordinates (x′, y′, z′) for conditioning the rendering MLPs.

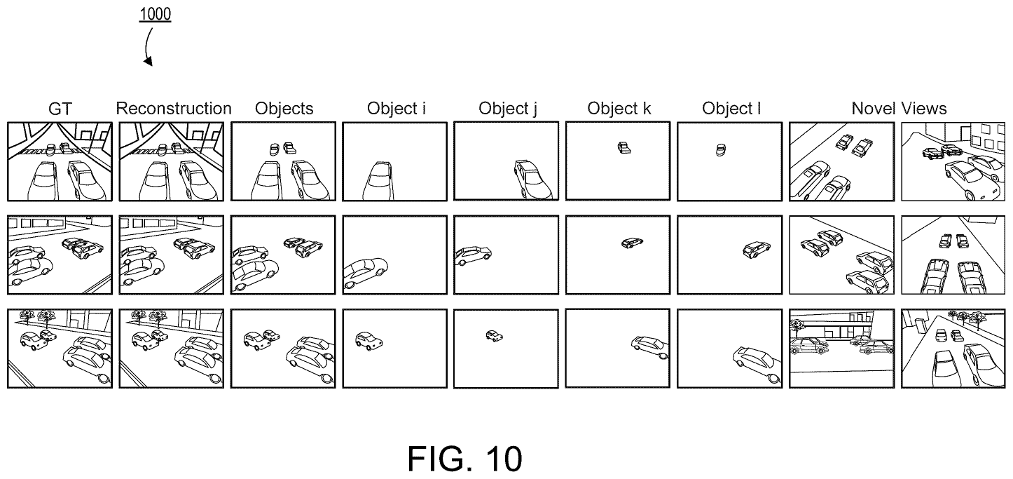

Given local and global features constructed from source views, the disclosed technology using NeRF decoder 268 decodes color cⁱₚ and density σⁱₚ for backgrounds using dedicated near and far background MLPs (Dₙₑₐᵣ and D_{far}). (Equation 4) after volumetrically rendering and compositing the near and far backgrounds and enforcing the loss as follows:

$$L = {‖ {C}_{p} - {\tilde{c}}_{t} ‖}_{2}^{2} + {λ}_{reg} {L}_{reg} + {λ}_{LPIPS} {L}_{LPIPS} \qquad ( Equation 8 )$$

where [symbol] is the sampled pixel locations from the target image and c^{P} is the composited color obtained from the rendering output of near and far background MLPs of NeRF decoder 268 as cᵢ^{P}=cᵢ^{nb}+ [symbol] _{_(j<i)} (1−σⱼ^{nb})cᵢ^{nb}. In an example embodiment it is preferred for the weights of the near and far background MLPs of NeRF decoder 268 to be sparse for efficient rendering by enforcing an additional distortion regularization loss and use L_{LPIPS} since this encourages perceptual similarity between patches of rendered color, c^{P} and ground color [symbol] , where this is only enforced after 30 training epochs in one example to improve background modeling as further described below in connection with FIG. 10. λ_{LPIPS} refers to the weighting factor of loss for L_{LPIPS}, while λ_{reg} refers to the weighting factor of L_{reg}.

With regard to scene editing and decomposition, given 3D bounding boxes obtained from a detector, the NeRF decoder 268 can obtain individual object and background radiance fields for each object simply by sampling rays inside the 3D bounding boxes of the objects and bilinearly interpolating the features at those specific (x,y,z) locations in the triplanar feature grid (S), making it straightforward to edit out and re-render individual objects.

FIG. 10 is an illustration 1000 showing qualitative results according to one example, specifically, scene decomposition quality results showing a 3-view scene decomposed into individual objects i, j, k, I along with novel views on the NeRDS360 dataset. The proposed approach can perform accurate decomposition by sampling inside the 3D bounding boxes of the objects, thus giving full control over object editability from very few input views. As illustrated in FIG. 10, accurate object re-rendering can be performed by considering the features inside the 3D bounding boxes of objects to render the foreground MLP of the NeRF decoder 268. In essence, the NeRF decoder 268 divides the combined editable scene rendering formulation as rendering objects, near and far backgrounds. For far backgrounds, the NeRF decoder 268 retrieves the scene color cᵢ^{b} and density σᵢ^{b} which is unchanged from the original rendering formulation. For near backgrounds, the NeRF decoder 268 obtains color cᵢ^{nb} and density σᵢ^{nb} after pruning rays inside the 3D bounding boxes of objects (for example, setting σᵢ^{b} to a high value, e.g., 10-5, before volumetrically rendering). For objects, only rays inside the bounding boxes of each objects are considered, and sampling inside the foreground MLP to retrieve cᵢ^{o} and density σᵢ^{b}. The individual opacities and colors are aggregated along the ray to render composited color using Equation 5.

c=Σᵢ [symbol] ᵢ^{b}cᵢ^{b}+Σᵢ [symbol] ᵢ^{nb}cᵢ^{nb}Σᵢ [symbol] ᵢ^{o}cᵢ^{o} (Equation 9)

Equation 9 illustrates aggregating the individual opacities and colors along the ray to render a composited color c. Here, cᵢ^{b} refers to the scene color for far backgrounds, cᵢ^{nb} refers to the scene color for near backgrounds, and cᵢ^{o} refers to the scene color for the foreground. Similarly, [symbol] ᵢ^{b} refers to the weight associated with the far background, [symbol] ᵢ^{nb} refers to the weight associated with the near background, and [symbol] ᵢ^{o} refers to the weight associated with the foreground.

While volumetric reconstruction methods traditionally use the generated volume solely for indoor geometry reconstruction, the present disclosure shows that the generated volume can also be employed in a computationally efficient way to estimate the entire scene's appearance and enable accurate neural rendering.

### Example Implementation—Network Architecture Details

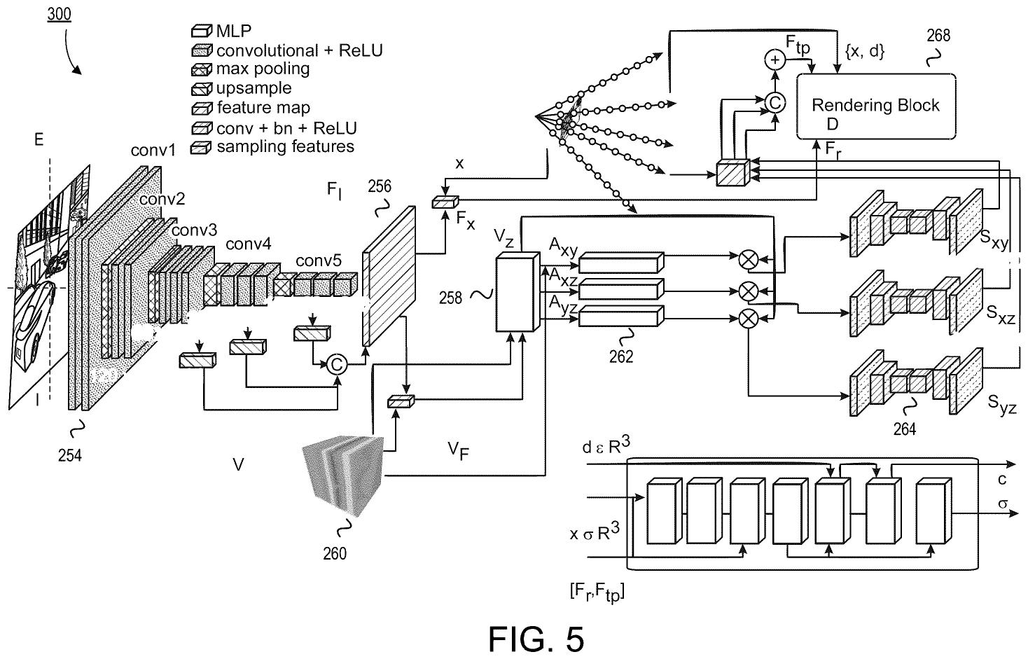

FIG. 5 provides a detailed architecture diagram and description according to an example embodiment of the present disclosure. More specifically, FIG. 5 shows an architectural design or system 300 according to another example embodiment of the present disclosure. Some aspects of system 300 of FIG. 5 are similar to the system 200 of FIG. 4 and therefore their components are given like reference numerals. FIG. 5 provides further detail as to the image-conditional triplanar representation discussed earlier. An example of an encoder will first be described, followed by further details of the triplanar features and residual features, and then further details of the rendering MLPs of NeRF decoder 268.

FIG. 5 illustrates the NeO 360 system's 170 detailed model architecture showing the construction of image-conditional triplanes along with local residual features and rendering MLPs to output density and color for a 3D point x and viewing direction d.

### The Encoder

The Encoder network E, shown as image encoder 254, comprises in one example a pre-trained Resnet32 backbone. The image encoder 254 extracts features from the initial convolutional layer and subsequent layer 1 to layer 3 and up-samples all features to the same spatial resolution (i.e., (H/2×W/2)), where W and H are image dimensions, respectively, before concatenating along the feature dimension to output feature map Fl with dimensions 512×H/2×W/2, as shown in the example of FIG. 5.

### Image-Conditional Tri-Planar Features and Residual Features

With respect to volumetric local features, local feature map Fl is backed along every ray to the world grid (V) to obtain 3D feature volume feature V_{F} with dimensions K×K×K×512, where K is the resolution of feature grid and K=64 in this example. Note that there is a tradeoff between the size of the feature grid, between expressivity and computational cost. K=64 was found in this example to give a reasonable performance while avoiding any out-of-memory (OOM) issues due to a larger grid size in the network training.

### Feature Depth Encoding

The depth of each feature in the feature grid is learned using an additional two-layer MLP (MLP 258) with hidden dimension 512 to output depth-encoded features V_{z} of dimensions K×K×K×512 in this example. The feature aggregation module 262 comprises in one example three two-layer MLPs 262a, 262b, 262c with hidden dimension 512 and outputs learned weights wᵢ over individual volumetric feature dimensions to output weights w_{xy}, w_{xz} and w_{yz} each with dimensions K×K×K×1. After performing a function such as Softmax and summing over the Z, Y, and X dimensions respectively, 2D feature maps are obtained for each of the three planes with dimension K×K×512.

### 2D Convolutions

A series of 2D convolutions with up-sampling layers are used to transform the planar features to dimension H/2×W/2×128. In this example the convolutional layers comprise three convolutional layers with input channels 512, 256, and 128 and output channels 256, 128, and 128 respectively, with a kernel size of 3, a stride of 2, and a padding of 1, followed by an up-sampling layer with a scale factor of 2 and another convolutional layer with an input channel and output channel of 128. Next, an up-sampling layer with an output dimension of H/2×W/2 is employed before outputting the features with a final convolution layer with input and output channels 128. All convolutional layers are followed by the BatchNorm and ReLU layers. BatchNorm is a standard deep learning layer that standardizes the input for each mini batch for that layer. ReLU is another standard layer used in deep learning to provide non-linear activation which aids in learning.

The output of each convolutional block becomes tri-planar features S, each with dimension 128×120×160 in this example. The system samples into each plane in S by projecting x into each plane, i.e., by getting the absolute xy, xz and yz coordinates of x before concatenating and summing over the channel dimension to retrieve feature fₜₚ with dimension “N×128,” where N denotes the number of sampled points and 128 is the feature dimension. The residual local feature fᵣ after sampling into Fl has dimensions N×512 in this example.

### Rendering MLPs

The rendering MLPs of NeRF decoder 268 for both foreground and background rendering comprise in this example seven fully connected layers with hidden dimension of 128 and ReLU (non-linear activation function) activation. Positional encoding is applied to the input positions x and viewing direction d. Positions x are concatenated with triplanar features fₜₚ and residual features fᵣ as an input to the first layer of the MLP. Further, the conditioning feature is also supplied as a skip connection to a third layer in the MLP and mean-pool the features along the viewing dimension in a fourth MLP layer, if there is more than one image in the input. The inventors found this pooling strategy to work better than pooling before the rendering stage, i.e., earlier on in the triplanar construction stage. In total, the first four layers are used in this example to output features of dimension N×128, before utilizing a final density MLP to output 1 channel value for every sampled point N. Two additional dedicated MLP layers are used in this example, with a hidden dimension of 128, to output a three-channel color value for every sampled point N, conditioned on the positionally encoded viewing direction and the output of the fourth MLP layer.

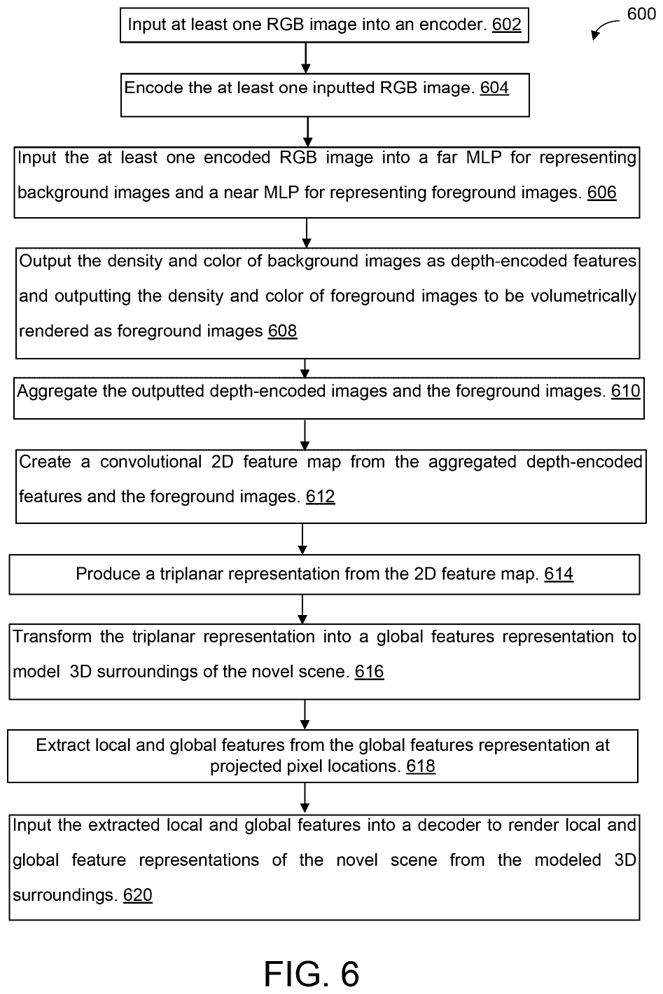

FIG. 6 shows a computer-implemented method 600 for sparse novel view synthesis of outdoor or novel scenes using neural fields according to an example embodiment. The method 600 may be performed, for example, by the NeO 360 system 170 of FIG. 1, as shown in more detail in FIG. 2. The method may be implemented by a processor 110 and memory 210. In one example the method 600 is implemented by the modules 219-223. The method 600 may be implemented by the systems 200 and 300 shown in FIGS. 4 and 5, respectively. Of course, the present disclosure is not limited to these examples.

Step 602 includes inputting at least one posed RGB image of the novel scene into an encoder (e.g., encoder 254 of FIG. 2, 4 or 5). In one example the number of the posed RGB images input into the encoder is from 1 to 5. Accordingly, in step 602, at least one single-view RGB observation is given as an input. In particular the system database 240 of FIG. 2 includes an RGB image 252. In one non-limiting example, the RGB image 252 is captured by an RGB camera of a vehicle such as the vehicle 2 of FIG. 1 or a robotics device or the like. The RGB image 252 may include multiple objects, and the multiple objects may be of the same or different types. The RGB image 252 comprises an RGB component and a Depth component. In an example, the RGB image 252 includes vehicles that surround the vehicle 2. In an example the encoder 254 uses a trained encoder network as described in more detail herein.

Step 604 includes encoding with the encoder 254 the at least one inputted posed RGB image. In step 606, the at least one encoded RGB image is output from the encoder 254 and input into a far multi-layer perceptron (MLP) (e.g., far MLP 258 of FIG. 2, 4, or 5) for representing background images and a near multi-layer perceptron (MLP) (e.g., near MLP 260 of FIG. 2, 4, or 5) for representing foreground images. In an example the far MLP 258 and the near MLP 260 are neural networks.

Step 608 includes outputting the density and color of background images from the far MLP 258 as depth-encoded features and outputting the density and color of foreground images from the near MLP 260 to be volumetrically rendered as foreground images. Step 610 includes aggregating the outputted depth-encoded images and the foreground images. In one example feature aggregation engine 262 of FIG. 2, 4, or 5 may perform this step.

Step 612 includes creating a convolutional two-dimensional (2D) feature map from the aggregated depth-encoded features and the foreground images. The feature map engine 256 and the 2D convolution engine 264 of FIG. 2, 4, or 5 may be used for this step. In step 614, a triplanar representation is produced from the 2D feature map. Then, in step 616, the triplanar representation is transformed into a global features representation to model 3D surroundings of the novel scene. In one example the triplanar representation comprises three axis-aligned orthogonal planes, and a respective feature map is obtained for each of the three axis-aligned orthogonal planes using the far MLP 258. The triplanar representation may comprise three perpendicular cross-planes, each cross-plane modeling the 3D surroundings from a corresponding perspective, wherein the cross-planes are merged to produce the local and global features.

Step 618 includes extracting local and global features from the global features representation at projected pixel locations. Step 620 includes inputting the extracted local and global features into a decoder to render local and global feature representations of the novel scene from the modeled 3D surroundings. The decoder may be NeRF decoder 268 of FIG. 2, 4, or 5. The decoder 268 may comprise one or more rendering MLPs. In one example the decoder 268 predicts a color and density for an arbitrary 3D location and a viewing direction from the triplanar representation. The decoder 268 uses near and far rendering MLPs to decode color and density used to render the local and global feature representations of the novel scene. The near and far rendering MLPs output density and color for a 3D point and a viewing direction. The novel scene is rendered in a 360 degree view.

### Another Example Implementation

Sampling rays: In one example, all samples in the dataset are scaled so that cameras lie inside a unit hemisphere and use near and far values of 0.02 and 3.0, respectively. In one embodiment 64 coarse and 64 fine samples are used to sample each ray.

Training procedure: Referring back to the training stage a) of FIG. 3, to optimize the NeO 360 system 170 according to one example, 3 source images are sampled from one of the 75 scenes in the training dataset. For the initial training phase, the system samples 20 random destination views different from the source images used for encoding the NeO 360 system's 170 network. 1000 rays are sampled from all 20 destination views. These randomly sampled rays are used to decode the color and density for each of the 1000 rays. This training strategy helps the NeO 360 system's 170 network simultaneously decode from a variety of camera distributions and helps with network convergence. This can be done by sampling two different sets of points, one for each near and far background MLP 702, 704. These points samples differ based on the intersection between the origin of rays and the unit sphere.

Loss function and optimizer: For the first training phase, a mean squared error loss is employed on predicted color and target pixels at the sampled point locations in the ground-truth images. A regularization penalty is added (see Equation 9 below) to encourage the weights to be sparse for both near and far background MLPs 702, 704. For the second training phase, a single destination view is selected, and 40×40 patches of target RGB are sampled for training the network using an additional perceptual similarity loss with a λ value set to 0.3. L_{LPIPS} loss encourages perceptual similarity between patches of rendered color, c^{P} and ground color ^{˜}cₜ, where this is only enforced after 30 training epochs in this example to improve background modeling. The NeO 360 system's 170 network is optimized for 100 epochs in total in this example, and early stopping is employed based on the validation dataset which is a subset of the training dataset with different viewpoints from the training camera distribution. An Adam optimizer is used in this example with an initial learning rate of 5.0e⁻⁴ and a learning-rate ramp-up strategy to increase the learning rate from 5.0e⁻⁵ to the value 5.0e⁻⁴ and then decrease it exponentially to a final learning rate 5.0e⁻⁶.

Compute: The model in this example is trained end-to-end on 8 A-100 Nvidia GPUs for approximately 1 day for network convergence.

Parameters: Since the NeO 360 system 170 has the ability to overfit to a large number of scenes unlike NeRF, a larger model size of 17M parameters is used. Both the NeO 360 system 170 and NeRF's rendering MLP size is the same (i.e., 1.2M parameters), although the larger model size of the NeRF system 170 can be attributed to employing ResNet feature block for local features (˜10M parameters) and additional convolutional blocks for the triplanar feature.

Optional fine-tuning: Although the NeO 360 system's 170 network gives reasonable zero-shot performance, the system also employs an additional fine tuning stage using the same few views (e.g. 1, 3, and 5 source views) to further improve the performance of the network. It is noted that the NeO 360 system 170 employs the same fine tuning strategy for the comparing baselines and the additional fine tuning stage can improve the performance of both the proposed method and the competing baseline, while the NeO 360 system 170 still achieves superior overall performance. For the fine tuning experiments, the rest of the network was frozen and only the triplanar network was optimized, i.e., freezing the encoder E. A lower learning rate of 5^{10 \hat{ }-6} was employed to fine tune the network from 1, 3, or 5 source views.

$${ℒ}_{reg} ( s , 𝓌 ) = {\sum }_{i = 0}^{N - 1} {𝓌}_{i} {𝓌}_{j} \vert \frac{{s}_{i} + {s}_{i + 1}}{2} - \frac{{s}_{j} + {s}_{j - 1}}{2} \vert + \frac{1}{3} {\sum }_{i = 0}^{N - 1} {𝓌}_{i}^{2} ( {s}_{i + 1} - {s}_{i} ) \qquad ( Equation 10 )$$

Here, [symbol] _{reg} refers to the regularization or distortion loss, s is the midpoint interval at each point and w refers to the volume rendering weights of each point. This loss encourages the weights to be compact to avoid floater artifacts, which are floaters or flawed geometry rendered outside the camera trajectory.

Experimental Setting Details: An example experimental setting is detailed herein to evaluate the effectiveness of the proposed method against the state-of-the-art baselines on the NeRDS360 dataset. This is mainly evaluated for a) prior-based sampling and b) novel-scene rendering. Here it is noted that unlike a system which performs both unconditional and conditional prior-based sampling, the task at hand only considers image-conditional prior-based sampling for a), since a latent code is not optimized for each scene and the proposed method does not rely on inference-time GAN inversion to find a latent code for a new scene. Rather, the proposed method works in a zero-shot manner reasonably well without any inference time finetuning or inversion, since it takes as its input one or few images or a novel scene and is trained as such.

Further details are now described about each experimental setting according to one example. First, a) prior-based sampling tests for the proposed network's ability to overfit to the training distribution of a large number of scenes. In essence, the evaluation scenes are kept fixed to one of the scenes seen during training and 1, 3, and 5 source camera views are used as inputs while decoding from novel camera viewpoints not seen during training. While vanilla NeRF can do this with many different networks, each optimized from scratch from 100s of views for a new scene, the proposed approach, due to its generalizability, can overfit to a large number of scenes with just a single network without optimizing a different latent code or vector per-scene, hence demonstrating the proposed network's ability to memorize the training distribution for a large number of scenes seen during training.

Next, b) novel scene rendering considers evaluating the proposed approach on a completely new set of scenes and objects never seen during training. The proposed model is tested for its ability to generalize well in this scenario which is a core aspect of the proposed approach. This can be a more challenging evaluation setup than prior-based sampling since the network has not seen any scenes or objects, neither has the network seen these viewpoints during training. Rather, in this example the network only relies on the priors learned during training and the few views available during testing (1, 3, or 5 views in this example evaluation setup) to infer the complete 360° surroundings of novel scenes.

### NeRDS 360 Multi-View Dataset for Outdoor Scenes

Task and Evaluation: Due to the challenge of obtaining accurate ground-truth 3D and 2D information (such as denser viewpoint annotations, 3D bounding boxes, and semantic and instance maps), only a handful of outdoor scenes have been available for training and testing. Specifically, previous formulations have focused on reconstructions using existing outdoor scene datasets offering panoramic views from the camera mounted on an ego vehicle. These datasets offer little overlap between adjacent camera views, a characteristic known to be useful for training NeRFs and multi-view reconstruction methods. Moreover, the optimization of object-based neural radiance models for these scenes becomes more challenging as the ego vehicle is moving fast and the object of interest is observed in just a few views (usually less than five).

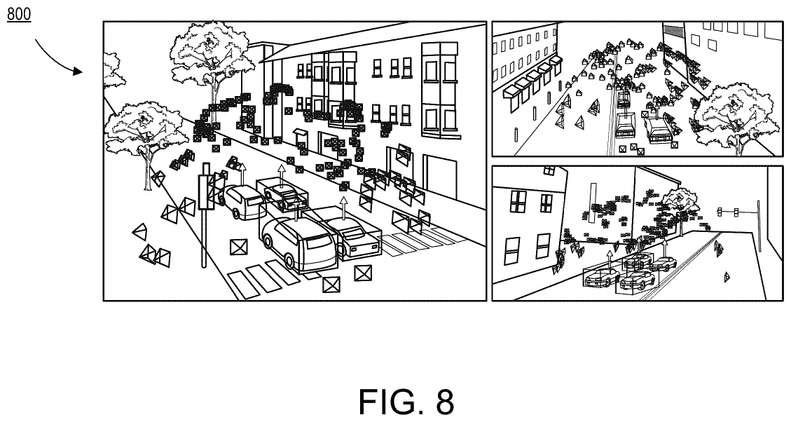

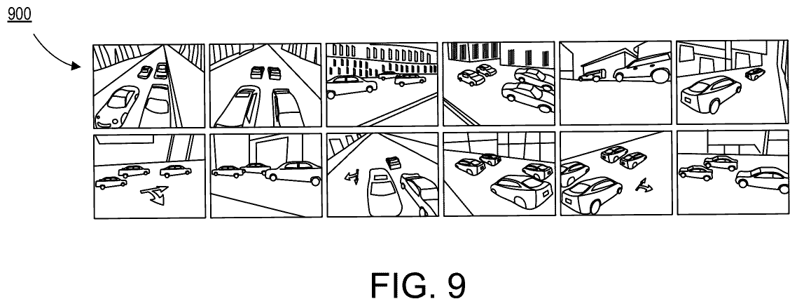

Dataset: To address these challenges, the disclosed technology can utilize a large scale dataset for 3D urban scene understanding. Compared to existing datasets, an example dataset of the present disclosure comprises 75 outdoor urban scenes with diverse backgrounds (comprising over 15,000 images) and offering 360° hemispherical-views around diverse foregrounds under various illuminations, as shown in FIG. 8, as opposed to only forward driving scenes with limited overlap and coverage between camera views. Existing datasets comprise mostly indoor objects and do not provide multiple foreground objects or background scenes. The disclosed technology uses the Parallel Domain synthetic data generation to render high-fidelity 360° scenes. Three different maps are selected, for example, SF 6thAndMission, SF GrantAndCalifornia, and SF VanNessAveAndTurkSt, and 75 different scenes are sampled across all three maps as the backgrounds. 20 different cars in 50 different textures are selected in this example for training and from 1 to 4 cars are randomly sampled to render in a scene. This dataset is referred to herein as NeRDS360. FIG. 9 is an illustration 900 of a proposed multi-view dataset for 360 neural scene reconstructions for outdoor scenes. In total, 15k renderings are generated by sampling 200 cameras in a hemispherical dome at a fixed distance from the center of cars. 5 scenes were held out with 4 different cars and different backgrounds for testing, comprising 100 cameras distributed uniformly sampled in the upper hemisphere, different from the camera distributions used for training. The diverse validation camera distributions were used to test for the ability of the disclosed technology to generalize to unseen viewpoints as well as unseen scenes during training.

As shown in FIG. 8, the dataset and corresponding task is extremely challenging due to occlusions, diversity of backgrounds, and rendered objects with various lightning and shadows. This task entails performing 360° few-view novel view synthesis of both objects and backgrounds using a handful of observations, e.g., 1 to 5, and evaluating using all 100 hemispherical views in this example. Accordingly, FIG. 8 shows an illustration 800 of an example camera distribution for 1, 3, and 5 source views and evaluation views. Thus, strong priors are required for novel view synthesis.

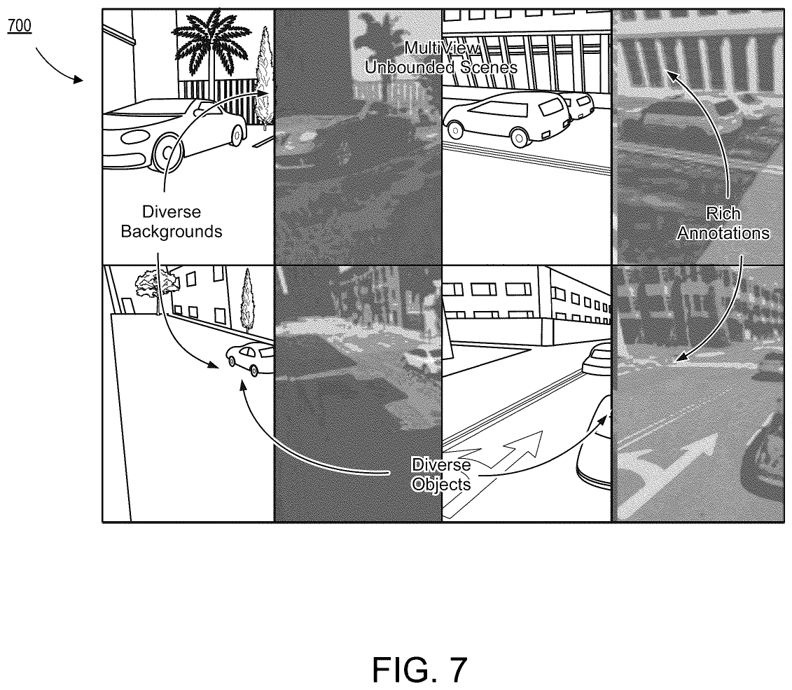

FIG. 7 is an illustration 700 showing samples from the NeRDS360 dataset comprising, in one example, more than 70 unbounded scenes with full multi-view annotations and diverse scenes. FIG. 7 shows samples of diverse backgrounds, multi-view unbounded scenes, rich annotations, and diverse objects. Qualitative examples include training samples of 3 different scenes from each of the 3 different maps in the proposed dataset. The proposed dataset is quite diverse both in terms of the scenes represented and the foreground vehicle shapes and textures. NeRDS360's scenes also depict high variety in terms of occlusion of foreground objects (i.e., not all foreground vehicles are observed from all views and there are various occluders such as trees and lightning poles that are present in the scene), a varied number of objects represented (e.g., from 1 to 4 foreground cars are sampled for each scene with various textures, lightning, and shadows) as well as varied lighting and shadows in a scene (i.e., lightning and shadows in each scene may not be constant). Thus the dataset and the corresponding task can be challenging. Different testing samples can render completely novel viewpoints not seen during training as well as different textures and shapes of vehicles that are also not rendered during training.

Additional Qualitative Results: The NeO 360 network's predicted few-view 360° novel view-synthesis is shown in a zero-shot manner on unseen scenes and objects, not observed during training. The proposed method performs plausible novel-view synthesis of complete scenes including far-away backgrounds and objects from very few sparse views of an outdoor scene, thus demonstrating the ability of the NeO 360 system 170 to use learned priors effectively. The 3-view synthesis introduces some artifacts in parts of the scene where there is no overlap between source views, i.e., where the scene is entirely unobserved. By adding a few sparse sets of views in those areas (e.g., a 5-view case), those artifacts can be effectively removed and a smooth scene representation can be obtained. This shows the proposed network's ability to interpolate smoothly across given source views and also complete the scene in an effective manner.

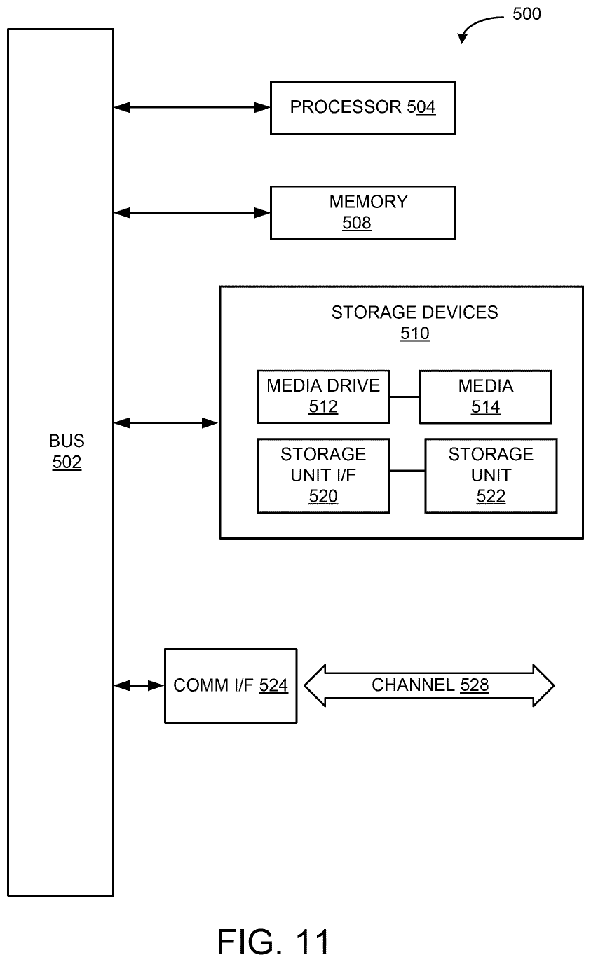

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 11, which may be implemented in many applications including robotics and/or vehicle applications including but not limited to grasping, manipulation, augmented reality, scene understanding, autonomous navigation, or others. Various embodiments are described in terms of this example-computing component 500. After reading this description, it will become apparent to a person skilled in the relevant art how to implement the application using other computing components or architectures.

Referring now to FIG. 11, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor, and/or any one or more of the components making up the NeO 360 system 170, the image encoder module 219, the 3D feature grid module 220, the feature aggregation module 221, the triplane feature module 222, or the NeO 360 decoder and volumetric rendering model 223. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

It should also be noted that the terms “optimize,” “optimal,” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for single-view three-dimensional (3D) few-view novel-view synthesis of a novel scene, comprising:
inputting at least one posed RGB image of the novel scene into an encoder;
encoding with the encoder the at least one inputted posed RGB image and inputting the at least one encoded RGB image into a far multi-layer perceptron (MLP) for representing a density and color of background images and a near multi-layer perceptron (MLP) for representing a density and color of foreground images;
outputting the density and color of background images from the far MLP as depth-encoded features, to be volumetrically rendered as background images and outputting the density and color of foreground images from the near MLP to be volumetrically rendered as foreground images;
aggregating the outputted depth-encoded images and the foreground images;
creating a convolutional two-dimensional (2D) feature map from the aggregated depth-encoded features and the foreground images;
producing a triplanar representation from the 2D feature map;
transforming the triplanar representation into a global features representation to model 3D surroundings of the novel scene;
extracting local and global features from the global features representation at projected pixel locations; and
inputting the extracted local and global features into a decoder to render local and global feature representations of the novel scene from the modeled 3D surroundings.

2. The method of claim 1, wherein a number of the posed RGB images input into the encoder is from 1 to 5.

3. The method of claim 1, wherein the encoder uses a trained encoder network.

4. The method of claim 1, wherein the near and far MLPs are neural networks.

5. The method of claim 1, wherein the triplanar representation comprises three axis-aligned orthogonal planes.

6. The method of claim 5, further comprising obtaining a respective feature map for each of the three axis-aligned orthogonal planes.

7. The method of claim 1, wherein the triplanar representation comprises three perpendicular cross-planes, each cross-plane modeling the 3D surroundings from a corresponding perspective, and the method further comprises merging the cross-planes to produce the global features.

8. The method of claim 1, wherein the decoder comprises one or more rendering MLPs.

9. The method of claim 1, wherein the decoder predicts a color and density for an arbitrary 3D location and a viewing direction from the triplanar representation.

10. The method of claim 1, wherein the decoder uses near and far rendering MLPs to decode color and density used to render the local and global feature representations of the novel scene.

11. The method of claim 9, wherein the near and far rendering MLPs output density and color for a 3D point and a viewing direction.

12. The method of claim 1, wherein the novel scene is rendered in a 360 degree view.

13. A system, comprising:
a processor; and a memory coupled to the processor to store instructions which, when executed by the processor, cause the processor to perform operations, the operations comprising:
encoding at least one RGB image from a novel scene and inputting the at least one encoded image into a far multi-layer perceptron (MLP) for representing background images and a near multi-layer perceptron (MLP) for representing foreground images;
outputting the background images from the far MLP as depth-encoded features, and outputting the foreground images from the near MLP;
aggregating the outputted depth-encoded images and the foreground images;
creating a convolutional two-dimensional (2D) feature map from the aggregated depth-encoded features and the foreground images;
producing a triplanar representation from the 2D feature map;
transforming the triplanar representation into a global features representation to model 3D surroundings of the novel scene;
extracting local and global features from the global features representation at projected pixel locations; and
decoding the extracted local and global features to render RGB representations of the novel scene from the modeled 3D surroundings.

14. The system of claim 13, wherein the encoding is performed using a trained encoder network.

15. The system of claim 13, wherein the near and far MLPs are neural networks.

16. The system of claim 13, wherein the triplanar representation comprises three axis-aligned orthogonal planes.

17. The system of claim 13, wherein the decoding is performed using one or more rendering MLPs.

18. The system of claim 13, wherein the decoding includes predicting a color and density for an arbitrary 3D location and a viewing direction from the triplanar representation.

19. A vehicle comprising the system of claim 13.

20. A non-transitory machine-readable medium having instructions stored therein, which, when executed by a processor, cause the processor to perform operations, the operations comprising:
encoding at least one RGB image from a novel scene and inputting the at least one encoded image into a far multi-layer perceptron (MLP) for representing background images and a near multi-layer perceptron (MLP) for representing foreground images;
outputting the background images from the far MLP as depth-encoded features, and outputting the foreground images from the near MLP;
aggregating the outputted depth-encoded images and the foreground images;
creating a convolutional two-dimensional (2D) feature map from the aggregated depth-encoded features and the foreground images;
producing a triplanar representation from the 2D feature map;
transforming the triplanar representation into a global features representation to model 3D surroundings of the novel scene;
extracting local and global features from the global features representation at projected pixel locations; and
decoding the extracted local and global features to render local and global feature representations of the novel scene from the modeled 3D surroundings.
